(19) United States
(12) Patent Application Publication
(10) Pub. No.: US 2026/0313016 A1
(43) Pub. Date: Oct. 8, 2026

(54) STREAMING METHOD FOR CLOUD MOBILE PHONES AND STREAMING SYSTEM FOR CLOUD MOBILE PHONES

(71) Applicant: Guangzhou Duling Technology Co., Ltd., Guangzhou (CN)

(72) Inventors: Simin CHEN, Guangzhou (CN); Dongsheng LIU, Guangzhou (CN); Zhenjie HE, Guangzhou (CN); Zhao WAN, Guangzhou (CN); Bingjian ZOU, Guangzhou (CN); Dongming ZHUANG, Guangzhou (CN); Qiang WU, Guangzhou (CN); Jinhui ZHANG, Guangzhou (CN); Liping LI, Guangzhou (CN); Jun LIN, Guangzhou (CN)

(21) Appl. No.: 19/429,913

(22) Filed: Dec. 22, 2025

(30) Foreign Application Priority Data
Mar. 19, 2025 (CN) 202510331095.3

(51) Int. Cl. H04L 67/10

(52) U.S. Cl. CPC H04L 67/10

(57) ABSTRACT

A streaming method and a streaming system for a cloud phone are provided. An implementation of the method includes: in response to receiving a streaming request sent by a client, determining a terminal type of the client based on the streaming request; determining an initial streaming rule according to the terminal type, and sending the initial streaming rule to the client, so that the client determines a target streaming rule based on the initial streaming rule; and constructing a streaming service between a target cloud phone and the client according to the target streaming rule sent by the client, where the streaming service is used for remotely controlling the target cloud phone.

### CROSS-REFERENCE TO RELATED APPLICATIONS

This application claims the priority from Chinese Patent Application No. 202510331095.3, filed with the China National Intellectual Property Administration (CNIPA) on Mar. 19, 2025, the entire disclosure of which is hereby incorporated by reference.

### TECHNICAL FIELD

The present disclosure relates to the technical field of cloud computing, and in particular, to a streaming method and a streaming system for a cloud phone.

### BACKGROUND

Platform as a Service (PaaS) is applied in cloud computing technology and may manage multiple cloud phones configured in data centers. PaaS can provide services such as data center management, device management, device status monitoring, task scheduling, and device connection.

### SUMMARY

The present disclosure provides a streaming method and a streaming system for a cloud phone.

According to a first aspect of the present disclosure, a streaming method for a cloud phone is provided, including: in response to receiving a streaming request sent by a client, determining a terminal type of the client based on the streaming request; determining an initial streaming rule according to the terminal type, and sending the initial streaming rule to the client, so that the client determines a target streaming rule according to the initial streaming rule; and constructing a streaming service between a target cloud phone and the client according to the target streaming rule sent by the client, where the streaming service is used for remotely controlling the target cloud phone.

According to a second aspect of the present disclosure, a streaming method for a cloud phone is provided, including: in response to detecting a streaming request, sending the streaming request to a Platform as a Service (PaaS) platform; receiving and displaying an initial streaming rule sent by the PaaS platform; and sending a target streaming rule to the PaaS platform, so that the PaaS platform remotely controls a target cloud phone according to the target streaming rule, where the target streaming rule is generated based on the initial streaming rule.

According to a third aspect of the present disclosure, a streaming system for a cloud phone is provided, including: a client configured to: send a detected streaming request to a Platform as a Service (PaaS) platform, receive and display an initial streaming rule sent by the PaaS platform; and send a target streaming rule to the PaaS platform, where the target streaming rule is generated based on the initial streaming rule; and the PaaS platform configured to: receive the streaming request sent by the client, determine a terminal type of the client based on the streaming request; determine the initial streaming rule according to the terminal type; send the initial streaming rule to the client; and construct a streaming service between a target cloud phone and the client according to the target streaming rule sent by the client, where the streaming service is used for remotely controlling the target cloud phone.

According to a fourth aspect of the present disclosure, an electronic device is provided, including: at least one processor; and a memory communicatively connected to the at least one processor; where the memory stores instructions executable by the at least one processor, and the instructions, when executed by the at least one processor, cause the at least one processor to perform the method described in any implementation of the first aspect.

According to a fifth aspect of the present disclosure, an electronic device is provided, including: at least one processor; and a memory communicatively connected to the at least one processor; where the memory stores instructions executable by the at least one processor, and the instructions, when executed by the at least one processor, cause the at least one processor to perform the method described in any implementation of the second aspect.

According to a sixth aspect of the present disclosure, a non-transitory computer-readable storage medium storing computer instructions is provided, where the computer instructions are used to cause a computer to perform the method described in any implementation of the first aspect.

According to a seventh aspect of the present disclosure, a non-transitory computer-readable storage medium storing computer instructions is provided, where the computer instructions are used to cause a computer to perform the method described in any implementation of the second aspect.

It should be understood that the description in this section is not intended to identify key or critical features of the embodiments of the disclosure, nor is it intended to limit the scope of the disclosure. Other features of the present disclosure will become readily apparent from the following description.

### BRIEF DESCRIPTION OF THE DRAWINGS

The drawings are used to better understand the solution and do not constitute a limitation to the present disclosure.

FIG. 1 is a flowchart of a streaming method for a cloud phone according to an embodiment of the present disclosure;

FIG. 2 is a flowchart of a streaming method for a cloud phone according to another embodiment of the present disclosure;

FIG. 3 is a flowchart of a streaming method for a cloud phone according to yet another embodiment of the present disclosure;

FIG. 4 is a flowchart of a streaming method for a cloud phone according to still another embodiment of the present disclosure;

FIG. 5 is a flowchart of a streaming method for a cloud phone according to an embodiment of the present disclosure;

FIG. 6 is a schematic frame diagram of a streaming system for a cloud phone according to the present disclosure;

FIG. 7 is a schematic structural diagram of a streaming apparatus for a cloud phone according to an embodiment of the present disclosure;

FIG. 8 is a schematic structural diagram of a streaming apparatus for a cloud phone according to another embodiment of the present disclosure;

FIG. 9 is a block diagram of an electronic device for implementing the streaming method for a cloud phone according to an embodiment of the present disclosure.

### DETAILED DESCRIPTION OF EMBODIMENTS

The following describes exemplary embodiments of the present disclosure with reference to the accompanying drawings, which include various details of the embodiments of the present disclosure to facilitate understanding, and they should be regarded as merely exemplary. Therefore, those of ordinary skill in the art should recognize that various changes and modifications may be made to the embodiments described herein without departing from the scope and spirit of the present disclosure. Similarly, descriptions of well-known functions and structures are omitted in the following for clarity and conciseness.

It should be noted that the embodiments of the present disclosure and the features in the embodiments may be combined with each other without conflict. The present disclosure will be described in detail below with reference to the accompanying drawings and embodiments.

Cloud game applications (referred to as cloud games) are a gaming approach based on cloud computing. In the operation mode of cloud games, all games run on the server side, and the rendered game screens are compressed and transmitted to users via a network. On the client side, the user's game device does not require a high-end processor and graphics cards, and only needs basic video decompression capability.

Currently, regarding the configuration of streaming services for cloud phones and cloud platforms, users can only select image quality options at the client level, such as: Ultra HD, HD, and Standard Definition. Moreover, other related parameters such as video encoding formats, resolutions, and frame rates cannot be selected, and modifying and limiting streaming-related parameters can only rely on the release of the client.

The PaaS platform may provide services in different service scenarios, for example, it may provide services in scenarios such as cloud games, web search, and marketing. At the underlying level, the PaaS platform may provide services such as data center management, device management, virtualization configuration management, control node load balancing, device connection authentication, and device status monitoring for data centers; and at the upper-layer level, the PaaS platform may provide basic capabilities such as unified instance management, instance operation, task scheduling, standardized services, and device connection for the service layer of the client.

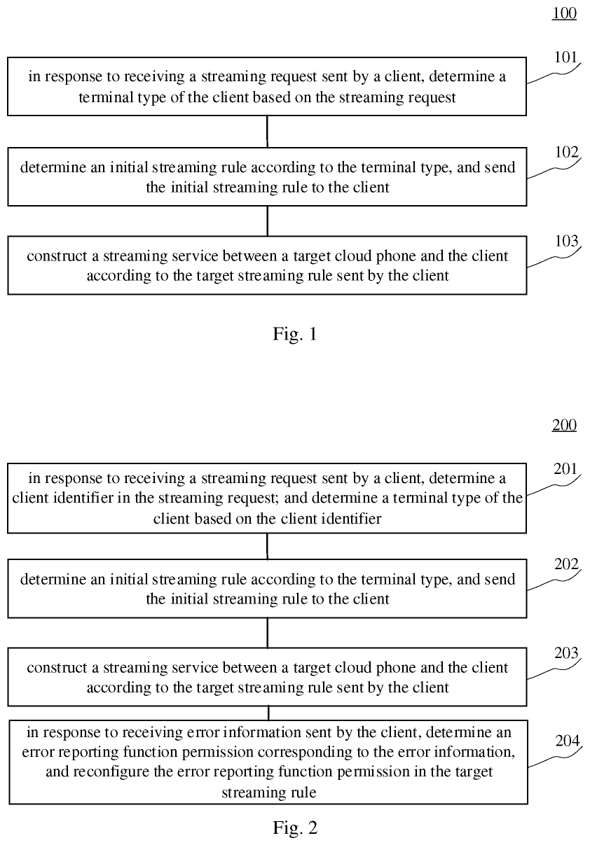

Referring to FIG. 1, it shows a process 100 of a streaming method for a cloud phone according to an embodiment of the present disclosure. The streaming method for a cloud phone is applied to a PaaS platform, including the following steps.

Step 101: in response to receiving a streaming request sent by a client, determining a terminal type of the client based on the streaming request.

In this embodiment, if an execution subject (PaaS platform) of the streaming method for a cloud phone receives a streaming request sent by a client, the execution subject determines the terminal type of the client sending the streaming request according to identifier information of the client included in the streaming request, where the terminal type may include a mobile terminal (e.g., Android terminal), a Personal Computer (PC) terminal, and an H5 (HTML5) terminal.

Specifically, when a user requests a streaming service by using a mobile terminal operating system, the sent streaming request includes an identifier corresponding to the mobile terminal, and in this case, the execution subject determines the terminal type of the client as the mobile terminal based on the identifier.

The PC terminal refers to a personal computer terminal, that is, when a user requests a streaming service by using a personal computer terminal, the sent streaming request includes an identifier corresponding to the PC terminal, and in this case, the execution subject determines the terminal type of the client as the PC terminal based on the identifier.

The H5 terminal is an abbreviation for a web page of the mobile terminal, developed by using HTML5 technology and can be directly accessed in a mobile phone browser, that is, when a user requests a streaming service by using a mobile phone browser, the sent streaming request includes an identifier corresponding to the H5 terminal, and in this case, the execution subject determines the terminal type of the client as the H5 terminal based on the identifier.

Step 102: determining an initial streaming rule according to the terminal type, and sending the initial streaming rule to the client.

In this embodiment, the execution subject determines the initial streaming rule according to the terminal type and sends the initial streaming rule to the client, so that the client determines a target streaming rule according to the initial streaming rule. Here, the execution subject pre-sets corresponding streaming rules for different clients, that is, each type of client corresponds to an initial streaming rule, and the streaming rules for different clients are set according to the characteristics and operation features of different clients. The initial streaming rule generally includes: a connection mode, video parameters, device control parameters and other rules. The connection mode includes multiple options that the user can select by himself/herself. The video coding parameters generally include: an H265 switch of a video stream, an H265 bit rate configuration of the video stream, an H264 bit rate configuration of the video stream, a frame rate of the video stream, a resolution of the video stream, etc. The device control parameters generally include: a streaming data marking switch, a camera function switch, a microphone function switch, a GPS positioning function switch, etc. The other rules may include an SDK version prohibition list and the like.

After determining the terminal type of the client sending the streaming request, the execution subject determines a corresponding streaming rule, that is, an initial streaming rule, according to the terminal type, and sends the initial streaming rule to the client.

For example, if the execution subject determines that the terminal type of the client is an Android terminal, it obtains a streaming rule corresponding to the Android terminal (Android terminal streaming rule) and sends the streaming rule as the initial streaming rule to the client.

For another example, if the execution subject determines that the terminal type of the client is a PC terminal, the execution subject obtains a streaming rule corresponding to the PC terminal (PC terminal streaming rule) and sends the streaming rule as the initial streaming rule to the client.

Step 103: constructing a streaming service between a target cloud phone and the client according to the target streaming rule sent by the client.

In this embodiment, after the execution subject sends the initial streaming rule to the client, the user may perform a selection and a setting in the initial streaming rule displayed on the client, to generate a target streaming rule, and the client sends the target streaming rule to the execution subject. Therefore, the execution subject constructs a streaming service between a target cloud phone and the client according to the target streaming rule sent by the client, where the streaming service is used for remotely controlling the target cloud phone. That is, after receiving the target streaming rule, the execution subject constructs a streaming service between the target cloud phone and the client, and the streaming service may be used by the client to remotely control the target cloud phone. In other words, the client may control the target cloud phone through the streaming service to perform operations such as accessing the target cloud phone. It should be noted that the construction and use of the streaming service are not specifically limited in this embodiment.

The streaming method for a cloud phone provided by the embodiment of the present disclosure includes: in response to receiving a streaming request sent by a client, first determining a terminal type of the client based on the streaming request; then determining an initial streaming rule according to the terminal type and sending the initial streaming rule to the client, so that the client determines a target streaming rule according to the initial streaming rule; and finally constructing a streaming service between a target cloud phone and the client according to the target streaming rule sent by the client. In the streaming method for a cloud phone in this embodiment, the PaaS platform is used as a streaming service console, and the PaaS platform may issue, according to a terminal type of a client, a streaming rule corresponding to the terminal type to the client, thereby realizing the issuance of streaming rules according to terminal type; and in addition, when the streaming rule needs to be changed, there is no need to update the version of the client, and it only needs the PaaS platform to re-issue a streaming rule to the client, thereby improving the update efficiency of the streaming rule.

In addition, in the technical solution related to the present disclosure, the acquisition, storage, use, processing, transmission, provision and disclosure of user personal information (such as the streaming request related to the present disclosure) all comply with the relevant laws and regulations and do not violate public order and good morals.

With continued reference to FIG. 2, FIG. 2 shows a process 200 of a streaming method for a cloud phone according to another embodiment of the present disclosure. The streaming method for a cloud phone includes the following steps.

Step 201: in response to receiving a streaming request sent by a client, determining a client identifier in the streaming request; and determining a terminal type of the client based on the client identifier.

In this embodiment, after receiving a streaming request sent by a client, an execution subject (PaaS platform) of the streaming method for a cloud phone first determines a client identifier included in the streaming request, and then determines a terminal type of the client according to the client identifier. That is, when users use different clients to make streaming requests, the streaming requests carry type information (i.e., terminal types) of different terminals used by the users, and the execution subject may determine a terminal type of a client by parsing the client identifier in the streaming request of the client. Thus, the terminal type of the client is accurately determined through the client identifier in the streaming request, and corresponding streaming rules may be issued according to different terminal types subsequently, thereby improving the accuracy of the issued streaming rule.

In some optional implementations of this embodiment, the terminal type includes a mobile terminal, a PC terminal and an H5 terminal; and determining the terminal type of the client based on the streaming request includes: in response to determining that the terminal type is the mobile terminal, determining the initial streaming rule as a mobile terminal streaming rule; in response to determining that the terminal type is the PC terminal, determining the initial streaming rule as a PC terminal streaming rule; and in response to determining that the terminal type is the H5 terminal, determining the initial streaming rule as an H5 terminal streaming rule.

In this implementation, if the execution subject determines that the terminal type of the client is a mobile terminal (e.g., Android terminal), the execution subject obtains a streaming rule corresponding to the mobile terminal (mobile terminal streaming rule) and send the streaming rule as the initial streaming rule to the client. If the execution subject determines that the terminal type of the client is a PC terminal, the execution subject obtains a streaming rule corresponding to the PC terminal (PC terminal streaming rule) and send the streaming rule as the initial streaming rule to the client. If the execution subject determines that the terminal type of the client is an H5 terminal, the execution subject obtains a streaming rule corresponding to the H5 terminal (H5 terminal streaming rule) and send the streaming rule as the initial streaming rule to the client. The execution subject may issue a streaming rule corresponding to a terminal type to a client according to the terminal type of the client, thereby realizing the issuance of streaming rules by terminal type dimension.

Step 202: determining an initial streaming rule according to the terminal type, and sending the initial streaming rule to the client.

Step 203: constructing a streaming service between a target cloud phone and the client according to the target streaming rule sent by the client.

Steps 202-203 are basically consistent with steps 102-103 of the foregoing embodiment, and for specific implementations, reference may be made to the foregoing description of steps 102-103, which will not be repeated here.

In some optional implementations of this embodiment, the target streaming rule includes: a connection mode parameter, a video coding parameter and/or a device control parameter. That is, the user can customize the connection mode, video coding parameters and/or device control information. The connection mode includes multiple options that the user can select by himself/herself. The video coding parameters generally include: an H265 switch of a video stream, an H265 bit rate configuration of the video stream, an H264 bit rate configuration of the video stream, a frame rate of the video stream, a resolution of the video stream, etc. The device control parameters generally include: a streaming data marking switch, a camera function switch, a microphone function switch, a GPS positioning function switch, etc. Thus, the user can customize relevant parameters in the streaming process of the cloud phone.

Step 204: in response to receiving error information sent by the client, determining an error reporting function permission corresponding to the error information, and reconfiguring the error reporting function permission in the target streaming rule.

In this embodiment, when a function of the client malfunctions, the user may report an error, and the client will send error information to the execution subject. After receiving the error information sent by the client, the execution subject will determine an error reporting function permission corresponding to the error information and reconfigure the error reporting function permission in the target streaming rule, so as to obtain a configured target streaming rule. Thus, the separate configuration of streaming rules for a single device is realized, thereby improving the user experience.

It can be seen from FIG. 2 that, compared with the embodiment corresponding to FIG. 1, the streaming method for a cloud phone in this embodiment may also determine an error reporting function permission corresponding to error information according to the error information sent by the client and reconfigure the error reporting function permission in the target streaming rule, thereby realizing the separate configuration of streaming rules for a single device and improving the user experience.

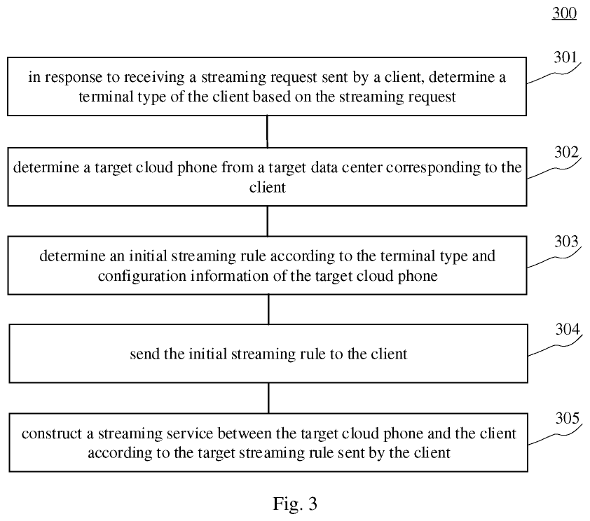

With continued reference to FIG. 3, FIG. 3 shows a process 300 of a streaming method for a cloud phone according to yet another embodiment of the present disclosure. The streaming method for a cloud phone includes the following steps.

Step 301: in response to receiving a streaming request sent by a client, determining a terminal type of the client based on the streaming request.

Step 301 is basically consistent with step 101 of the foregoing embodiment, and for a specific implementation, reference may be made to the foregoing description of step 101, which will not be repeated here.

Step 302: determining a target cloud phone from a target data center corresponding to the client.

In this embodiment, an execution subject of the streaming method for a cloud phone determines a target cloud phone from a target data center corresponding to the client. Specifically, the execution subject may determine an IP address corresponding to the client sending the streaming request, determine a target data center from a plurality of preset data centers according to the IP address, and then determine a target cloud phone from a plurality of cloud phones in the target data center. For example, the streaming request may include an IP address, that is, the IP address may be obtained from the streaming request. The IP address can represent the current geographic location of the client.

Step 303: determining an initial streaming rule according to the terminal type and configuration information of the target cloud phone.

In this embodiment, the execution subject comprehensively determines an initial streaming rule on the basis of the terminal type of the client and further in combination with configuration information of the target cloud phone. Here, the configuration information of the target cloud phone may be used to characterize whether the target cloud phone is a high configuration cloud phone or a low configuration cloud phone. If the target cloud phone is a low configuration cloud phone, some functions of the target cloud phone are disabled; if the target cloud phone is a high configuration cloud phone, corresponding high configuration functions are enabled for the target cloud phone.

For example, assuming that the terminal type of the client is an Android terminal in the mobile terminal, an Android terminal streaming rule is first obtained, where the Android terminal streaming rule includes: an Android SDK version prohibition list, Android connection mode selection, an Android streaming data marking switch, an Android camera function switch, an Android microphone function switch, an Android GPS positioning function switch, an Android H265 switch of a video stream, Android H265 bit rate configuration of the video stream, Android H264 bit rate configuration of the video stream, an Android frame rate of the video stream, and an Android resolution of the video stream. If the execution subject determines that the configuration information of the target cloud phone is a low configuration, the GPS positioning function, camera function and microphone function in the obtained Android terminal streaming rule are disabled, so as to obtain the initial streaming rule. If the configuration information of the target cloud phone is a high configuration, the GPS positioning function, camera function and microphone function in the obtained Android terminal streaming rule are enabled, that is, the obtained Android terminal streaming rule is used as the initial streaming rule. Thus, the initial streaming rule is comprehensively determined on the basis of the terminal type of the client and in combination with the configuration information of the target cloud phone, so that the determined initial streaming rule is more targeted.

Step 304: sending the initial streaming rule to the client.

In this embodiment, the execution subject sends the determined initial streaming rule to the client, so that the client determines a target streaming rule according to the initial streaming rule.

Step 305: constructing a streaming service between the target cloud phone and the client according to the target streaming rule sent by the client.

Step 305 is basically consistent with step 103 of the foregoing embodiment, and for a specific implementation, reference may be made to the foregoing description of step 103, which will not be repeated here.

It may be seen from FIG. 3 that, compared with the embodiment corresponding to FIG. 2, the streaming method for a cloud phone in this embodiment highlights the step of comprehensively determining an initial streaming rule according to the terminal type of the client and the configuration information of the target cloud phone, thereby improving the pertinence of the determined initial streaming rule.

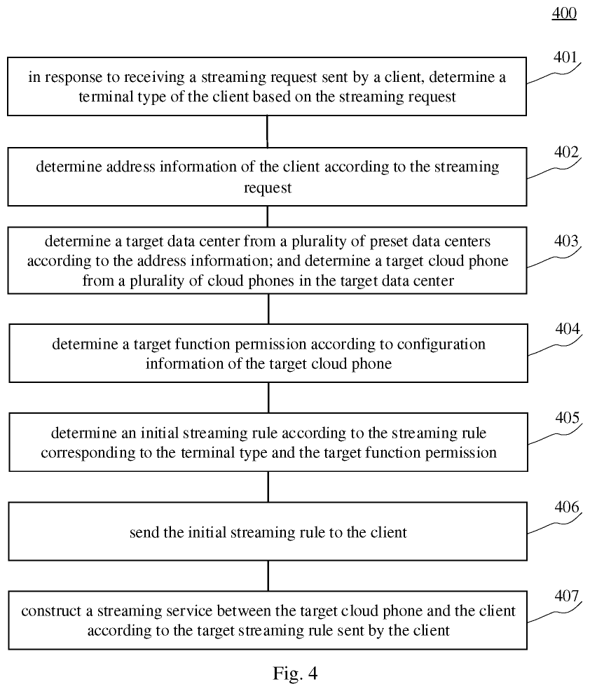

With continued reference to FIG. 4, FIG. 4 shows a process 400 of a streaming method for a cloud phone according to still another embodiment of the present disclosure. The streaming method for a cloud phone includes the following steps.

Step 401: in response to receiving a streaming request sent by a client, determining a terminal type of the client based on the streaming request.

Step 401 is basically consistent with step 101 of the foregoing embodiment, and for a specific implementation, reference may be made to the foregoing description of step 101, which will not be repeated here.

Step 402: determining address information of the client according to the streaming request.

In this embodiment, an execution subject of the streaming method for a cloud phone parses the streaming request to determine address information of the client, where the address information may be an IP address, and the IP address may represent the current geographic location of the client.

Step 403: determining a target data center from a plurality of preset data centers according to the address information; and determining a target cloud phone from a plurality of cloud phones in the target data center.

In this embodiment, the execution subject determines a target data center from a plurality of preset data centers according to the IP address, for example, the streaming request may include an IP address, that is, the IP address may be obtained from the streaming request. Then a target cloud phone is determined from a plurality of cloud phones in the target data center, that is, the streaming request may include a cloud phone identifier of a target cloud phone that the user wants to perform streaming or connection thereto, and the execution subject may determine the target cloud phone from a plurality of cloud phones in the target data center according to the cloud phone identifier. Thus, the target cloud phone for the streaming service is accurately determined.

Step 404: determining a target function permission according to configuration information of the target cloud phone.

In this embodiment, the execution subject first determines configuration information of the target cloud phone, where the configuration information may be used to characterize whether the target cloud phone is a high configuration cloud phone or a low configuration cloud phone. If the target cloud phone is a low configuration cloud phone, some functions of the target cloud phone are disabled; if the target cloud phone is a high configuration cloud phone, corresponding high configuration functions are enabled for the target cloud phone.

Step 405: determining an initial streaming rule according to the streaming rule corresponding to the terminal type and the target function permission.

In this embodiment, the execution subject comprehensively determines an initial streaming rule on the basis of the terminal type of the client and further in combination with configuration information of the target cloud phone. That is, the streaming rule corresponding to the terminal type is first obtained, and then the streaming rule is modified in combination with the target function permission, so as to obtain the initial streaming rule. Thus, the initial streaming rule is comprehensively determined on the basis of the terminal type of the client and in combination with the configuration information of the target cloud phone, so that the determined initial streaming rule is more targeted.

For example, assuming that the terminal type of the client is a PC terminal, a PC terminal streaming rule is first obtained, where the PC terminal streaming rule includes: a PC SDK version prohibition list, PC connection mode selection, a PC streaming data marking switch, a PC camera function switch, a PC microphone function switch, a PC GPS positioning function switch, a PC H265 switch of a video stream, a PC H265 bit rate configuration of the video stream, a PC H264 bit rate configuration of the video stream, a PC frame rate of the video stream, and a PC resolution of the video stream. Then the execution subject determines that the configuration information of the target cloud phone is a low configuration, and then the GPS positioning function, camera function and microphone function in the obtained PC terminal streaming rule are disabled, so as to obtain the initial streaming rule. If the configuration information of the target cloud phone is a high configuration, the GPS positioning function, then the camera function and microphone function in the obtained PC terminal streaming rule are enabled, that is, the obtained PC terminal streaming rule is used as the initial streaming rule.

For another example, assuming that the terminal type of the client is an H5 terminal, an H5 terminal streaming rule is first obtained, where the H5 terminal streaming rule includes: an H5 SDK version prohibition list, H5 connection mode selection, an H5 streaming data marking switch, an H5 camera function switch, an H5 microphone function switch, an H5 GPS positioning function switch, an H5 H265 switch of a video stream, an H5 H265 bit rate configuration of the video stream, an H5 H264 bit rate configuration of the video stream, an H5 frame rate of the video stream, and an H5 resolution of the video stream. Then the execution subject determines that the configuration information of the target cloud phone is a low configuration, and then the GPS positioning function, camera function and microphone function in the obtained H5 terminal streaming rule are disabled, so as to obtain the initial streaming rule. If the configuration information of the target cloud phone is a high configuration, then the GPS positioning function, camera function and microphone function in the obtained H5 terminal streaming rule are enabled, that is, the obtained H5 terminal streaming rule is used as the initial streaming rule.

Step 406: sending the initial streaming rule to the client.

In this embodiment, the execution subject sends the determined initial streaming rule to the client, so that the client determines a target streaming rule according to the initial streaming rule.

Step 407: constructing a streaming service between the target cloud phone and the client according to the target streaming rule sent by the client.

Step 407 is basically consistent with step 103 of the foregoing embodiment, and for a specific implementation, reference may be made to the foregoing description of step 103, which will not be repeated here.

It may be seen from FIG. 4 that, compared with the embodiment corresponding to FIG. 3, the streaming method for a cloud phone in this embodiment comprehensively determines an initial streaming rule on the basis of the terminal type of the client and in combination with the configuration information of the target cloud phone, so that the determined initial streaming rule is more targeted.

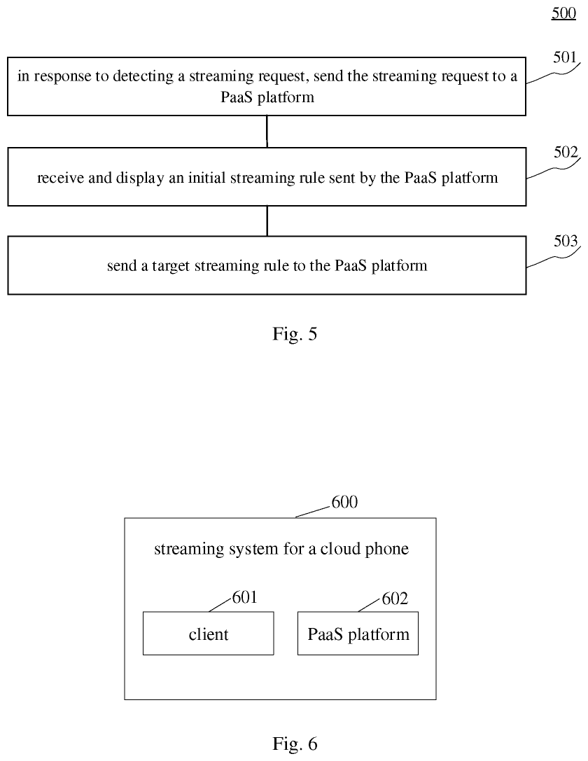

With continued reference to FIG. 5, it shows a process 500 of a streaming method for a cloud phone according to an embodiment of the present disclosure. The streaming method for a cloud phone is applied to a client, including the following steps.

Step 501: in response to detecting a streaming request, sending the streaming request to a PaaS platform.

In this embodiment, when an execution subject (client) of the streaming method for a cloud phone detects a user making a streaming request, the execution subject sends the streaming request to a PaaS platform. Generally, the streaming request may include: a terminal type of the client, address information of the client, and identifier information of a cloud phone designated by a user for streaming.

Step 502: receiving and displaying an initial streaming rule sent by the PaaS platform.

In this embodiment, after the execution subject sends the streaming request to the PaaS platform, the PaaS platform determines an initial streaming rule according to the information in the streaming request and sends the determined initial streaming rule to the execution subject, and the execution subject receives and displays the initial streaming rule sent by the PaaS platform.

Step 503: sending a target streaming rule to the PaaS platform.

In this embodiment, the user may further select and configure the streaming rule on the initial streaming rule displayed on the client according to actual needs, and generate a target streaming rule after the user completes the configuration, and the execution subject sends the target streaming rule to the PaaS platform, so that the PaaS platform remotely controls a target cloud phone according to the target streaming rule.

For example, the user may select, in the initial streaming rule, a specific prohibited Software Development Kit (SDK) version and a specific connection mode, select to turn on the camera, turn on the microphone, turn on the GPS positioning, etc., so as to obtain the target streaming rule.

In some optional implementations of this embodiment, the method further includes: in response to detecting error information, sending the error information to the PaaS platform, so that the PaaS platform changes the target streaming rule according to the error information.

In this implementation, if a function of the client malfunctions, the user may report an error, and after detecting the error information, the execution subject sends the error information to the PaaS platform. After receiving the error information sent by the client, the PaaS platform determines an error reporting function permission corresponding to the error information and reconfigure the error reporting function permission in the target streaming rule, that is, the PaaS platform changes the target streaming rule according to the error information. Thus, the separate configuration of streaming rules for a single device is realized, thereby improving the user experience.

The streaming method for a cloud phone provided by the embodiment of the present disclosure includes: in response to detecting a streaming request, first sending the streaming request to a PaaS platform; then receiving and displaying an initial streaming rule sent by the PaaS platform; and finally sending a target streaming rule to the PaaS platform. In the streaming method for a cloud phone in this embodiment, the user can customize the target streaming rule on the basis of the initial streaming rule, so that when the streaming rule needs to be changed, there is no need to update the version of the client, realizing a more convenient and fast configuration of streaming parameters of the cloud phone.

With continued reference to FIG. 6, it shows a schematic frame diagram of a streaming system for a cloud phone according to the present disclosure. As shown in FIG. 6, the system 600 may include a client 601 and a PaaS platform 602. The client 601 sends a detected streaming request to the PaaS platform 602, receives and displays an initial streaming rule sent by the PaaS platform 602, and sends a target streaming rule generated based on the initial streaming rule to the PaaS platform 602. The PaaS platform 602 receives the streaming request sent by the client 601, determines a terminal type of the client 601 based on the streaming request; determines an initial streaming rule according to the terminal type and send the initial streaming rule to the client 601; and constructs a streaming service between a target cloud phone and the client according to the target streaming rule sent by the client 601, where the streaming service is used for remotely controlling the target cloud phone.

That is, in this system, the PaaS platform initiates a “streaming rule” to the client, and the streaming rule includes: a connection mode, video parameters and other rules. The streaming rule is set through a User Interface (UI) page of the PaaS platform, the client calls an http interface to obtain connection device information, a json field is added to the original protocol when returning the device connection information, the client transmits the connection information to the SDK, and the SDK parses the streaming rule, reads the streaming rule field, and connects to the device according to the rule.

The streaming system for a cloud phone links the client SDK with the PaaS platform to realize the issuance of streaming rules according to different dimensions such as a single device, a network segment, and a device type, converting the action that could only be realized by updating the client into one that is realized by obtaining new parameters through an API. In addition, streaming rules can be issued according to different types of clients (Android, PC, H5 clients), supporting rules such as video stream parameters and sensor switches. Additionally, by customizing prohibited SDK versions and other streaming rules, the problem of being unable to perform damage control and rollback in the event of online issues is effectively resolved.

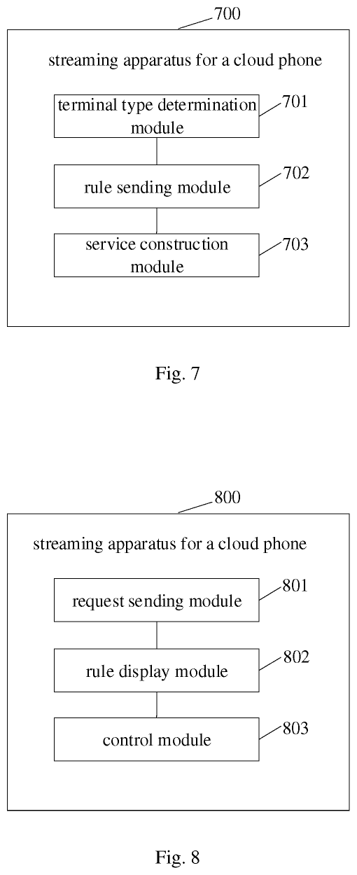

With further reference to FIG. 7, as an implementation of the methods shown in the above figures, the present disclosure provides an embodiment of a streaming apparatus for a cloud phone, which corresponds to the method embodiment shown in FIG. 1, and the apparatus may be specifically applied to various electronic devices.

As shown in FIG. 7, the streaming apparatus 700 for a cloud phone of this embodiment includes: a terminal type determination module 701, a rule sending module 702 and a service construction module 703. The terminal type determination module 701 is configured to, in response to receiving a streaming request sent by a client, determine a terminal type of the client based on the streaming request; the rule sending module 702 is configured to determine an initial streaming rule according to the terminal type and send the initial streaming rule to the client, so that the client determines a target streaming rule according to the initial streaming rule; and the service construction module 703 is configured to construct a streaming service between a target cloud phone and the client according to the target streaming rule sent by the client, where the streaming service is used for remotely controlling the target cloud phone.

In this embodiment, in the streaming apparatus 700 for a cloud phone: the specific processing of the terminal type determination module 701, the rule sending module 702 and the service construction module 703 and the technical effects brought thereby may refer to the relevant descriptions of steps 101-103 in the embodiment corresponding to FIG. 1, respectively, which will not be repeated here.

In some optional implementations of this embodiment, the terminal type determination module 701 is further configured to: determine a client identifier in the streaming request; and determine a terminal type of the client based on the client identifier.

In some optional implementations of this embodiment, the terminal type includes a mobile terminal, a PC terminal and an H5 terminal; and the rule sending module 702 is further configured to: in response to determining that the terminal type is the mobile terminal, determine the initial streaming rule as a mobile terminal streaming rule; in response to determining that the terminal type is the PC terminal, determine the initial streaming rule as a PC terminal streaming rule; and in response to determining that the terminal type is the H5 terminal, determine the initial streaming rule as an H5 terminal streaming rule.

In some optional implementations of this embodiment, the above streaming apparatus 700 for a cloud phone further includes: a cloud phone determination module configured to determine a target cloud phone from a target data center corresponding to the client; and the rule sending module 702 includes: a determination sub-module configured to determine an initial streaming rule according to configuration information of the target cloud phone and the terminal type.

In some optional implementations of this embodiment, the cloud phone determination module is further configured to: determine address information of the client according to the streaming request; determine a target data center from a plurality of preset data centers according to the address information; and determine the target cloud phone from a plurality of cloud phones in the target data center.

In some optional implementations of this embodiment, the determination sub-module is further configured to: determine a target function permission according to configuration information of the target cloud phone; and determine the initial streaming rule according to the streaming rule corresponding to the terminal type and the target function permission.

In some optional implementations of this embodiment, the above streaming apparatus 700 for a cloud phone further includes: a configuration module configured to, in response to receiving error information sent by the client, determine an error reporting function permission corresponding to the error information and reconfigure the error reporting function permission in the target streaming rule.

In some optional implementations of this embodiment, the target streaming rule includes: a connection mode parameter, a video coding parameter and/or a device control parameter.

With further reference to FIG. 8, as an implementation of the methods shown in the above figures, the present disclosure provides another embodiment of a streaming apparatus for a cloud phone, which corresponds to the method embodiment shown in FIG. 5, and the apparatus may be specifically applied to various electronic devices.

As shown in FIG. 8, the streaming apparatus 800 for a cloud phone of this embodiment includes: a request sending module 801, a rule display module 802 and a control module 803. The request sending module 801 is configured to, in response to detecting a streaming request, send the streaming request to a PaaS platform; the rule display module 802 is configured to receive and display an initial streaming rule sent by the PaaS platform; and the control module 803 is configured to send a target streaming rule to the PaaS platform, so that the PaaS platform remotely controls a target cloud phone according to the target streaming rule, where the target streaming rule is generated based on the initial streaming rule.

In this embodiment, in the streaming apparatus 800 for a cloud phone: the specific processing of the request sending module 801, the rule display module 802 and the control module 803 and the technical effects brought thereby may refer to the relevant descriptions of steps 501-503 in the embodiment corresponding to FIG. 5, respectively, which will not be repeated here.

In some optional implementations of this embodiment, the streaming apparatus 800 for a cloud phone further includes: an error reporting module configured to, in response to detecting error information, send the error information to the PaaS platform, so that the PaaS platform changes the target streaming rule according to the error information.

According to the embodiments of the present disclosure, the present disclosure also provides an electronic device, a readable storage medium and a computer program product.

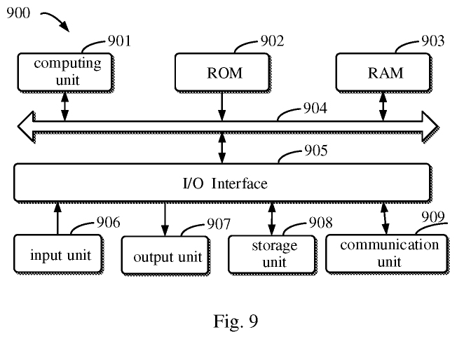

FIG. 9 shows a schematic block diagram of an example electronic device 900 that may be used to implement the embodiments of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as personal digital processors, cellular phones, smart phones, wearable devices, and other similar computing devices. The components shown herein, their connections and relationships, and their functions are merely examples, and are not intended to limit the implementation of the present disclosure described and/or claimed herein.

As shown in FIG. 9, the device 900 includes a computing unit 901, which can perform various appropriate actions and processes according to a computer program stored in a Read-Only Memory (ROM) 902 or a computer program loaded into a Random-Access Memory (RAM) 903 from a storage unit 908. Various programs and data required for the operation of the device 900 may also be stored in the RAM 903.

The computing unit 901, the ROM 902 and the RAM 903 are connected to each other through a bus 904. An Input/Output (I/O) interface 905 is also connected to the bus 904.

A number of components in the device 900 are connected to the I/O interface 905, including: an input unit 906 such as a keyboard, a mouse, etc.; an output unit 907 such as various types of displays, speakers, etc.; a storage unit 908 such as a magnetic disk, an optical disk, etc.; and a communication unit 909 such as a network card, a modem, a wireless communication transceiver, etc. The communication unit 909 allows the device 900 to exchange information/data with other devices through a computer network such as the Internet and/or various telecommunication networks.

The computing unit 901 may be various general-purpose and/or special-purpose processing components with processing and computing capabilities. Some examples of the computing unit 901 include, but are not limited to, a Central Processing Unit (CPU), a Graphics Processing Unit (GPU), various dedicated Artificial Intelligence (AI) computing chips, various computing units running machine learning model algorithms, a Digital Signal Processor (DSP), and any suitable processor, controller, microcontroller, etc. The computing unit 901 executes the various methods and processes described above, such as the streaming method for a cloud phone. For example, in some embodiments, the streaming method for a cloud phone may be implemented as a computer software program tangibly embodied in a machine-readable medium, such as the storage unit 908. In some embodiments, part or all of the computer program may be loaded and/or installed onto the device 900 via the ROM 902 and/or the communication unit 909. When the computer program is loaded into the RAM 903 and executed by the computing unit 901, one or more steps of the streaming method for a cloud phone described above may be performed. Alternatively, in other embodiments, the computing unit 901 may be configured to perform the streaming method for a cloud phone by any other suitable means (e.g., by means of firmware).

Various implementations of the systems and technologies described herein may be implemented in digital electronic circuit systems, integrated circuit systems, Field-Programmable Gate Arrays (FPGAs), Application-Specific Integrated Circuits (ASICs), Application-Specific Standard Products (ASSPs), System on Chip (SOC), Complex Programmable Logic Devices (CPLDs), computer hardware, firmware, software, and/or combinations thereof. These various implementations may include: being implemented in one or more computer programs that can be executed and/or interpreted on a programmable system including at least one programmable processor, which may be a special-purpose or general-purpose programmable processor that can receive data and instructions from a storage system, at least one input device, and at least one output device, and transmit data and instructions to the storage system, the at least one input device, and the at least one output device.

Program code for implementing the method of the present disclosure may be written in any combination of one or more programming languages. These program codes may be provided to a processor or controller of a general-purpose computer, a special-purpose computer, or other programmable data processing apparatus, so that the program codes, when executed by the processor or controller, cause the functions/operations specified in the flowcharts and/or block diagrams to be implemented. The program codes may be executed entirely on the machine, partly on the machine, as a stand-alone software package partly on the machine and partly on a remote machine, or entirely on the remote machine or server.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above. A more specific example of the machine-readable storage medium will include an electrical connection based on one or more wires, a portable computer diskette, a hard disk, a Random-Access Memory (RAM), a Read-Only Memory (ROM), an Erasable Programmable Read-Only Memory (EPROM or flash memory), an optical fiber, a portable Compact Disc Read-Only Memory (CD-ROM), an optical storage device, a magnetic storage device, or any suitable combination of the above.

To provide interaction with a user, the systems and technologies described herein may be implemented on a computer having: a display device (e.g., a Cathode Ray Tube (CRT) or a Liquid Crystal Display (LCD) monitor) for displaying information to the user; and a keyboard and a pointing device (e.g., a mouse or a trackball) through which the user can provide input to the computer. Other types of devices may also be used to provide interaction with the user; for example, the feedback provided to the user may be any form of sensory feedback (e.g., visual feedback, auditory feedback, or tactile feedback); and input from the user may be received in any form (including acoustic input, speech input, or tactile input).

The systems and technologies described herein may be implemented in a computing system including a back-end component (e.g., as a data server), or a middleware component (e.g., an application server), or a front-end component (e.g., a user computer with a graphical user interface or a web browser through which the user can interact with an implementation of the systems and technologies described herein), or any combination of such back-end components, middleware components, or front-end components. The components of the system may be interconnected by any form or medium of digital data communication (e.g., a communication network). Examples of communication networks include: a Local Area Network (LAN), a Wide Area Network (WAN), and the Internet.

The computer system may include a client and a server. The client and server are generally remote from each other and typically interact through a communication network. The relationship of client and server arises by virtue of computer programs running on the respective computers and having a client-server relationship to each other. The server may be a cloud server, or a server of a distributed system, or a server incorporating a blockchain.

It should be understood that the various forms of processes shown above may be used to reorder, add, or delete steps. For example, the steps recorded in the present disclosure may be executed in parallel, sequentially, or in a different order, as long as the desired result of the technical solution disclosed in the present disclosure can be achieved, and no limitation is made herein.

The above detailed description does not constitute a limitation to the scope of the present disclosure. It should be apparent to those skilled in the art that various modifications, combinations, sub-combinations and substitutions may be made according to design requirements and other factors. Any modifications, equivalent substitutions and improvements made within the spirit and principle of the present disclosure shall be included in the scope of the present disclosure.

1. A streaming method for a cloud phone, comprising:
in response to receiving a streaming request sent by a client, determining a terminal type of the client based on the streaming request;
determining an initial streaming rule according to the terminal type, and sending the initial streaming rule to the client, so that the client determines a target streaming rule according to the initial streaming rule; and
constructing a streaming service between a target cloud phone and the client according to the target streaming rule sent by the client, wherein the streaming service is used for remotely controlling the target cloud phone.

2. The method according to claim 1, wherein the determining the terminal type of the client based on the streaming request comprises:
determining a client identifier in the streaming request; and
determining the terminal type of the client based on the client identifier.

3. The method according to claim 1, wherein the terminal type comprises a mobile terminal, a PC terminal and an H5 terminal; and
the determining the initial streaming rule according to the terminal type comprises:
in response to determining that the terminal type is the mobile terminal, determining the initial streaming rule as a mobile terminal streaming rule;
in response to determining that the terminal type is the PC terminal, determining the initial streaming rule as a PC terminal streaming rule; and
in response to determining that the terminal type is the H5 terminal, determining the initial streaming rule as a H5 terminal streaming rule.

4. The method according to claim 3, further comprising:
determining the target cloud phone from a target data center corresponding to the client; and
the determining the initial streaming rule according to the terminal type further comprises:
determining the initial streaming rule according to configuration information of the target cloud phone and the terminal type.

5. The method according to claim 4, wherein the determining the target cloud phone from the target data center corresponding to the client comprises:
determining address information of the client according to the streaming request;
determining the target data center from a plurality of preset data centers according to the address information; and
determining the target cloud phone from a plurality of cloud phones in the target data center.

6. The method according to claim 4, wherein the determining the initial streaming rule according to the terminal type and configuration information of the target cloud phone comprises:
determining a target function permission according to the configuration information of the target cloud phone; and
determining the initial streaming rule according to the streaming rule corresponding to the terminal type and the target function permission.

7. The method according to claim 1, further comprising:
in response to receiving error information sent by the client, determining an error reporting function permission corresponding to the error information, and reconfiguring the error reporting function permission in the target streaming rule.

8. The method according to claim 1, wherein the target streaming rule comprises: a connection mode parameter; a video coding parameter; a device control parameter; the connection mode parameter and the video coding parameter; the connection mode parameter and the device control parameter; the video coding parameter and the device control parameter; or the connection mode parameter, the video coding parameter, and the device control parameter.

9. A streaming method for a cloud phone, comprising:
in response to detecting a streaming request, sending the streaming request to a Platform as a Service (PaaS) platform;
receiving and displaying an initial streaming rule sent by the PaaS platform;
sending a target streaming rule to the PaaS platform, so that the PaaS platform remotely controls a target cloud phone according to the target streaming rule, wherein the target streaming rule is generated based on the initial streaming rule.

10. The method according to claim 9, further comprising:
in response to detecting error information, sending the error information to the PaaS platform, so that the PaaS platform changes the target streaming rule according to the error information.

11. A streaming system for a cloud phone, comprising:
a client configured to: send a detected streaming request to a Platform as a Service (PaaS) platform, receive and display an initial streaming rule sent by the PaaS platform; and send a target streaming rule to the PaaS platform, wherein the target streaming rule is generated based on the initial streaming rule; and
the PaaS platform configured to: receive the streaming request sent by the client, determine a terminal type of the client based on the streaming request; determine the initial streaming rule according to the terminal type, and send the initial streaming rule to the client;
and construct a streaming service between a target cloud phone and the client according to the target streaming rule sent by the client, wherein the streaming service is used for remotely controlling the target cloud phone.

12. An electronic device, comprising:
at least one processor; and
a memory communicatively connected to the at least one processor; wherein
the memory stores instructions executable by the at least one processor, and the instructions, when executed by the at least one processor, cause the at least one processor to perform the method according to claim 1.

13. An electronic device, comprising:
at least one processor; and
a memory communicatively connected to the at least one processor; wherein
the memory stores instructions executable by the at least one processor, and the instructions, when executed by the at least one processor, cause the at least one processor to perform the method according to claim 9.

14. A non-transitory computer-readable storage medium storing computer instructions, wherein the computer instructions are used to cause a computer to perform the method according to claim 1.

15. A non-transitory computer-readable storage medium storing computer instructions, wherein the computer instructions are used to cause a computer to perform the method according to claim 9.
